(19) United States
(12) Patent Application Publication
(10) Pub. No.: US 2010/0040071 A1
(43) Pub. Date: Feb. 18, 2010

(54) COMMUNICATION SYSTEM

(75) Inventors: Kuniyasu Goto, Kawasaki (JP); Mitsutoshi Ikeda, Kawasaki (JP)

Correspondence Address: KATTEN MUCHIN ROSENMAN LLP, 575 MADISON AVENUE, NEW YORK, NY, 10022-2585, US

(73) Assignee: FUJITSU LIMITED, Kawasaki-shi (JP)

(21) Appl. No.: 12/535,265

(22) Filed: Aug. 4, 2009

(30) Foreign Application Priority Data
Aug. 13, 2008 (JP) 2008-208345

(51) Int. Cl. H04L 12/56

(52) U.S. Cl. 370/400

(57) ABSTRACT

A communication system for performing communications on a network, including: a user terminal; and an edge node disposed at an edge of a provider domain and having a transfer control portion for controlling forwarding of packets forwarded from an originating user terminal or packets forwarded from another edge node. When definitions of important flow packets are set in the edge node, the transfer control portion establishes a connection for transfer of important flow packets between an edge node with which the originating user terminal is connected and an edge node with which a destination user terminal is connected.

### CROSS-REFERENCE TO RELATED APPLICATION(S)

This application is based upon and claims the benefit of priority of the prior Japanese Patent Application No. 2008-208345, filed on Aug. 13, 2008, the entire contents of which are incorporated herein by reference.

### BACKGROUND

The present invention relates to a communication system for performing communications on an IP (Internet Protocol) network.

### DESCRIPTION OF THE RELATED ART

In communication networks, techniques for providing QoS (Quality of Service) are employed to assure certain communication speed and quality by reserving a bandwidth for certain communications. There is an increasing need for a technique that assures QoS in order to offer communication services giving high levels of satisfaction to users. Main techniques for providing QoS include QoS forwarding and packet forwarding fault detection method.

(1) QoS Forwarding

In an OSI (Open Systems Interconnection) network complying with X.25 (protocol suite for packet exchange for connection type data communications), a calling control function using X.25 signaling is imparted to each of end nodes (X.25 terminals) and network nodes (X.25 switching equipment) to control QoS forwarding.

Specific examples of the method of controlling QoS forwarding include (a) prioritized forwarding in which certain calls are forwarded with priority, (b) bandwidth-controlled forwarding in which the forwarding bandwidth is controlled for each call, and (c) destination reachability checking method in which a check is made as to whether a certain call has arrived at its destination. These three methods are realized on an OSI network.

On the other hand, techniques of QoS forwarding currently generally used in IP networks are as follows.

(a) The prioritized forwarding has been replaced by differentiated service (Diffserv) technology.

(b) The bandwidth-controlled forwarding has been replaced by Integrated Services (Intserv) technology using RSVP (Resource reSerVation Protocol) signaling.

(c) The destination reachability checking method has been replaced by TCP (Transmission Control Protocol) forwarding using a transport layer.

The Diffserv controls prioritized forwarding of traffic by combining plural communication streams into one class, assuring QoS for each class, and making the plural classes different in forwarding performance.

In particular, at each end node (IP terminal), packets are classified according to flow type. In the case of IPv4, DSCP (Differentiated Services Code Point) that is classification information is written (referred to as marking), using 6 bits of an 8-bit TOS (Type of Service) field of the IP packet.

At each network node (IP router), packets are forwarded by referring to the value of DSCP and classifying the packets according to PHB (Per-Hop Behavior: describing rules regarding the operation of a node corresponding to Diffserv) defined by the value of DSCP.

The Intserv assures QoS for each communication flow and secures a forwarding bandwidth between an end node and a network node by using an RSVP that is a signaling protocol for reserving the bandwidth in the network.

Furthermore, in TCP-based transmission at a transport layer, a connection is established between an end node and a network node. An ACK is sent out to indicate that packets have been received. Thus, destination reachability is checked.

(2) Packet Forwarding Fault Detection Method

In an OSI network, the status of each call is monitored. A decision can be made according to the status of the call as to whether or not packets should be forwarded. For example, if the call is established, forwarding of packets is enabled. If the call is disconnected, forwarding of packets is disabled.

On the other hand, on an IP network, hop-by-hop forwarding is performed. That is, the destination address of each forwarded packet is collated against a next hop in a routing table at each node and then packets are forwarded.

When a fault occurs, ICMP (Internet Control Message Protocol) is used as a fault-detecting protocol to permit a router located along the route to inform the sender of the fault.

When packets are forwarded in a hop by hop manner, if the decision made at a node along the route is “Destination Unreachable”, the node generates an ICMP destination unreachable message (ICMP Unreachable) and sends the message to the judged packet-forwarding node (source address). Consequently, the forwarding node receiving the ICMP Unreachable message can detect that a fault has occurred in packet forwarding.

A conventional technique regarding assurance of QoS is proposed in JP-A-2004-159021. In particular, protocol processing independent of the platform is performed by transparently passing encapsulated IP packets through a protocol control program and forwarding the packets to an application program.

JP-A-2002-141945 discloses a technique for prioritizing packets containing important information by setting degrees of priority according to the types of data stored within the packets and sending the packets to a network.

The above-described QoS forwarding is now discussed consciously of a network management domain. Where the network management domain is separated into a service provider and users, the QoS forwarding cannot be controlled unless the service provider is interposed regarding the aforementioned prioritized forwarding, bandwidth-controlled forwarding, and destination reachability checking executed by an OSI network.

Also, in an IP network, when Diffserv-based priority forwarding or RSVP-based bandwidth-controlled forwarding is done, intervention of a service provider is necessary. However, with respect to TCP-based destination reachability checking, intervention of a provider is not required at all.

As a result, the service provider can assure the user of destination reachability on an OSI network. However, on an IP network, the provider cannot.

That is, in the prior art network technique complying with X.25, the network grasps the status of call control or connection. Therefore, communication carrier or service provider can assure the user communication (i.e., reachability of user data). However, on an IP network, there is the problem that a provider cannot assure reachability of user data, which has been heretofore ensured by the conventional network technique complying with X.25.

The aforementioned method of detecting a fault in packet forwarding consciously of a network management domain is next described. Where the network management domain is separated into a service provider and users, information about the status of calls is shared between the provider and users on an OSI network.

Therefore, the user and provider can simultaneously detect whether a call is disconnected or not. Furthermore, the user and provider can simultaneously determine whether or not packets are forwarded. On an OSI network, the provider and user can judge whether or not packets can be forwarded.

On the other hand, on an IP network, if packets are judged to be “Destination Unreachable” at a network node along a forwarding route as described previously, an ICMP unreachable message is sent to the end node. The end node receives the message. As a result of this procedure, both the user and provider detect the fault.

In the case of an IP network, it is assumed that the routing table at each node is modified dynamically. That is, control is made assuming that when a next user packet is forwarded, the destination unreachability ceases, that is, a new next host is found. Therefore, if packets forwarded by a node along the route are judged to be Destination Unreachable, it is unlikely that the IP network continually suffers from a packet forwarding fault.

In this way, on an IP network, if forwarded packets do not reach their destination, their Destination Unreachability is found. However, there is the problem that in a case where a next packet is transferred after the decision of Destination Unreachability or in a case where a packet is transferred after an interval since the transfer of the previous packet, it is impossible to make a decision as to whether or not packets can be forwarded.

In view of the foregoing, the present invention has been made. It is an object of the invention to provide a communication system offering improved network quality and serviceability by making it possible to check the destination reachability of forwarded packets on an IP network and to make a decision as to whether or not packets can be forwarded.

### SUMMARY

A communication system for performing communications on a network, comprises; a user terminal; and an edge node disposed at an edge of a provider domain and having a transfer control portion for controlling forwarding of packets forwarded from an originating user terminal or packets forwarded from another edge node; wherein when definitions of important flow packets are set in the edge node, said transfer control portion establishes a connection for transfer of important flow packets between an edge node with which the originating user terminal is connected and an edge node with which a destination user terminal is connected and makes a decision based on the definitions of the important flow packets as to whether user flow packets forwarded from the originating user terminal are important flow packets; and wherein if the decision is that the user flow packets are the important flow packets, the transfer control portion encapsulates the packets and forwards them through said connection for transfer of the important flow packets.

### BRIEF DESCRIPTION OF THE DRAWINGS

FIG. 1 is a diagram illustrating the principle of operation of a communication system;

FIG. 2 is a conceptual diagram illustrating flow of important flow packets and general flow packets that are forwarded;

FIG. 3 is a table illustrating the contents of the definitions of important flow packets;

FIG. 4 is a diagram showing the structure of a communication system;

FIG. 5 is a diagram illustrating a sequence of steps performed until a connection for transfer of important flow packets is automatically established;

FIG. 6 is a flowchart illustrating processing of packets performed after a flow decision;

FIG. 7 is a diagram illustrating processing steps for searching for important flow packets;

FIG. 8 is a diagram illustrating a connection header for transfer of important flow packets;

FIG. 9 is a diagram illustrating a sequence of steps performed to check the destination reachability when user's packets are communicated, as well as a sequence of steps performed to detect a forwarding fault;

FIG. 10 is a diagram similar to FIG. 9, but in which user's packets are not being communicated; and

FIG. 11 is a diagram illustrating a sequence of steps performed to measure the packet transfer time.

### DETAILED DESCRIPTION OF THE EMBODIMENTS

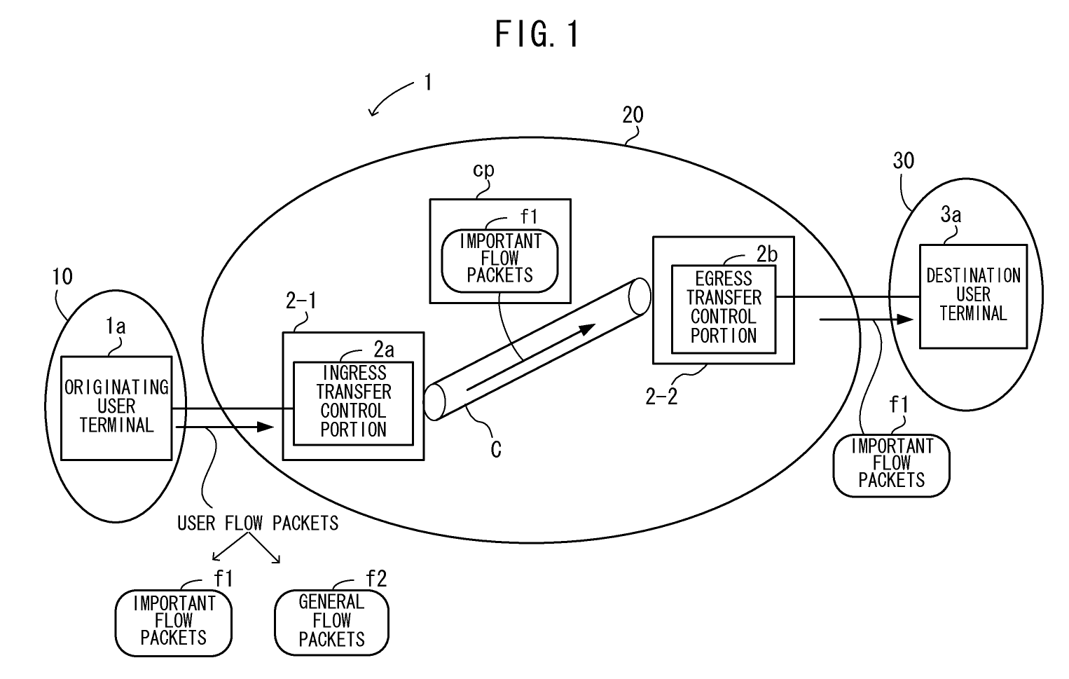

Embodiments of the present invention are hereinafter described with reference to the drawings. FIG. 1 illustrates the principle of operation of a communication system. The communication system, generally indicated by reference numeral 1, performs communications on an IP network including user domains 10, 30 and a provider domain 20. The communication system 1 is composed of an originating user terminal 1a, a destination user terminal 3a, an ingress edge node 2-1, and an egress edge node 2-2. Packets treated by the present invention are IP packets.

The originating user terminal 1a is located within the user domain 10 and connected with the ingress edge node 2-1. The destination user terminal 3a is located within the user domain 30 and connected with the egress edge node 2-2.

The ingress edge node 2-1 includes an ingress transfer control portion 2a and is positioned at an ingress edge of the provider domain 20. The ingress transfer control portion 2a controls forwarding of packets transferred from the originating user terminal 1a.

The egress edge node 2-2 includes an egress transfer control portion 2b and is disposed at an egress edge of the provider domain 20. The egress transfer control portion 2b controls forwarding of packets transferred from the ingress edge node 2-1.

A connection C for transfer of important flow packets is established between the ingress transfer control portion 2a and the egress transfer control portion 2b within the provider domain 20. The connection C is a logical connection.

User flow packets that are traffic flow of user packets are forwarded from the originating user terminal 1a. On receiving the user flow packets, the ingress transfer control portion 2a makes a decision as to whether the user flow packets are important flow packets f1 or general flow packets f2.

The important flow packets f1 are encapsulated to create encapsulated important flow packets cp, which are then forwarded through the connection C for transfer of important flow packets. The general flow packets f2 are forwarded to the destination user terminal 3a by hop-by-hop forwarding that is ordinary IP routing.

The egress transfer control portion 2b decapsulates the encapsulated important flow packets cp received through the connection C for transfer of important flow packets and forwards the decapsulated important flow packets f1 to the destination user terminal 3a.

The important flow packets f1 are user flow packets which have been contracted between the user and the provider and whose destination reachability should be assured. Information about the definitions of the important flow packets is written in the important flow packets f1.

The important flow packets f1 are encapsulated and forwarded within the provider domain 20 and so destination reachability is assured. In addition, secrecy is assured. The general flow packets f2 are user flow packets other than the important flow packets f1.

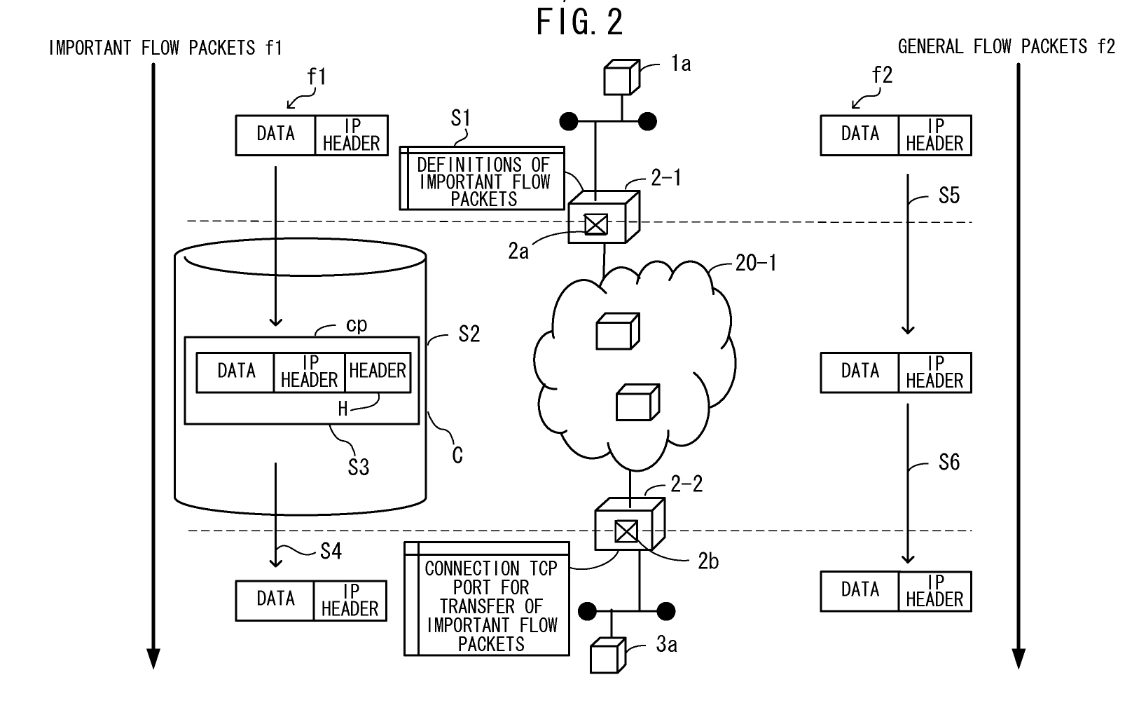

FIG. 2 is a conceptual diagram illustrating the flow of the important flow packets f1 and general flow packets f2 forwarded. Steps S1-S4 illustrate the flow of the important flow packets f1. Steps S5 and S6 illustrate the flow of the general flow packets f2.

Important flow packet definitions for searching the received user flow packets to know whether or not they are important flow packets f1 are set in an access control list (ACL) within the ingress transfer control portion 2a located inside the ingress edge node 2-1 (step S1). The access control list is a list of conditional statements setting forth that the transmission of packets from a certain user terminal is allowed or refused.

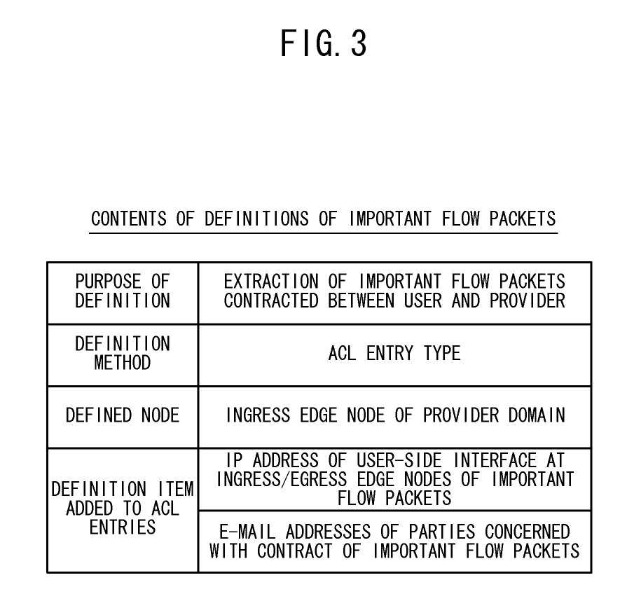

The definitions of the important flow packet include, for example, the IP addresses of the interfaces (I/Fs) of the user sides of the ingress edge node 2-1 and egress edge node 2-2, as well as the email addresses of the parties concerned with the contract of the important flow packets. The definitions of the important flow packets are listed in FIG. 3. For example, the IP addresses are the I/F address on the user side of the ingress edge node 2-1 connected with the originating user terminal 1a and the I/F address on the user side of the egress edge node 2-2 connected with the destination user terminal 3a. The email addresses are those of persons in charge of users, provider's sales staff in charge of users, and provider's maintenance personnel, etc.

When the definitions of the important flow packets are set in the ingress edge node 2-1, the ingress transfer control portion 2a establishes the connection C for transfer of important flow packets from the ingress edge node 2-1 toward the egress edge node 2-2 to a provider network 20-1 inside the provider domain 20 (step S2).

Specifically, the definitions of the important flow packets are introduced into the ingress edge node 2-1. Thus, the connection C for transfer of the important flow packets destined for the IP address of the I/F on the user side of the egress edge node 2-2 is automatically established.

When the connection C for transfer of the important flow packets is established, the TCP port (port number) of the connection C for transfer of the important flow packets is stored in the ingress transfer control portion 2a at the ingress edge node 2-1 and in the egress transfer control portion 2b at the egress edge node 2-2.

The stored TCP port for the connection for transfer of the important flow packets is reflected in a connection header H for transfer of the important flow packets in the ingress edge node 2-1. In the egress edge node 2-2, the stored TCP port is used to make a decision as to whether the received packets are the important flow packets f1.

On receiving the user flow packets forwarded from the originating user terminal 1a, the ingress transfer control portion 2a extracts the important flow packets f1 based on the definitions of the important flow packets. The control portion 2a attaches the connection header H for transfer of the important flow packets, encapsulates the important flow packets f1 to create the encapsulated important flow packets cp, and forwards the encapsulated important flow packets cp through the connection C for transfer of the important flow packets (step S3).

The egress transfer control portion 2b decapsulates the encapsulated important flow packets cp received through the connection C for transfer of the important flow packets, and forwards the decapsulated important flow packets f1 to the destination user terminal 3a (step S4).

The originating user terminal 1a transfers the general flow packets f2 to the ingress edge node 2-1. On receiving the general flow packets f2 forwarded from the originating user terminal 1a, the ingress transfer control portion 2a transfers the packets to the provider network 20-1 by normal IP routing (step S5).

On receiving the general flow packets f2 forwarded through the provider network 20-1 by the IP routing, the egress transfer control portion 2b transfers the general flow packets f2 to the destination user terminal 3a (step S6).

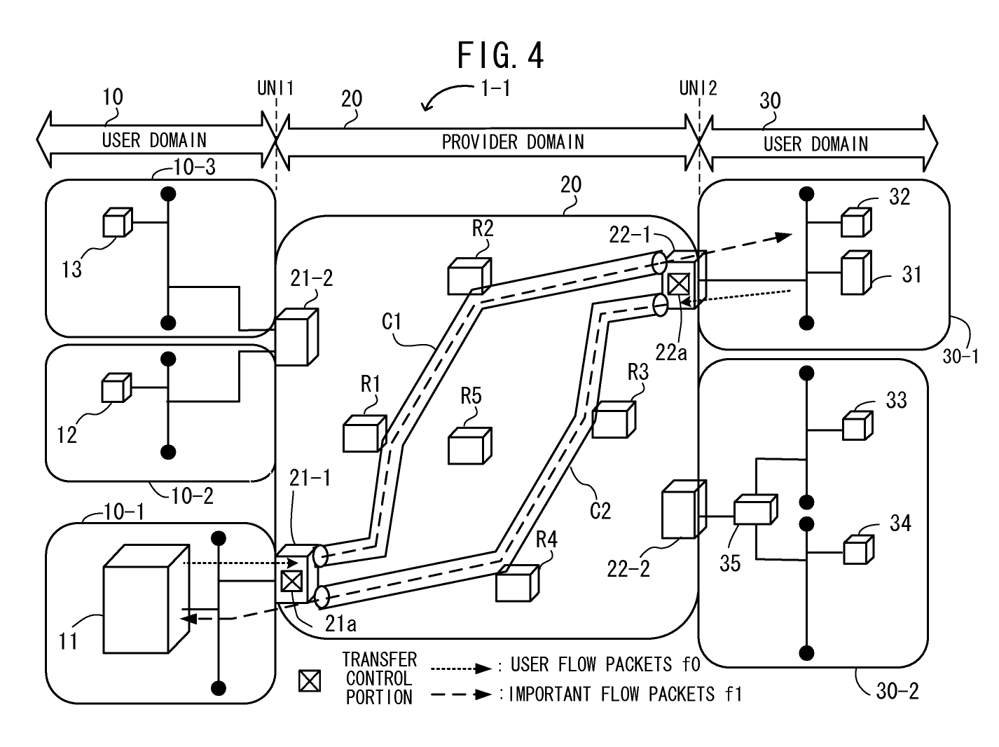

A specific example of structure of the communication system 1 in the IP network is next described. FIG. 4 shows the structure of a communication system. The communication system, generally indicated by reference numeral 1-1, performs communications on an IP network including user domains 10 (10-1, 10-2, 10-3), 30 (30-1, 30-2) and a provider domain 20.

The user domains 10-1 to 10-3 are connected with the provider domain 20 via a UNI (User Network Interface) 1 that is the junction between the provider's communication facility and the users' communication facility. The user domains 30-1 and 30-2 are connected with the provider domain 20 via a UNI 2.

The provider domain 20 contains edge nodes 21-1, 21-2, 22-1, 22-2 and core nodes R1-R5 having routing functions. The edge nodes 21-1 and 21-2 are located at edges on a side of the UNI 1. The edge nodes 22-1 and 22-2 are located at edges on a side of the UNI 2.

The inside of each of the user domains 10-1 to 10-3 is composed of a bus-structured network. In FIG. 4, a basic task system center 11 is positioned in the user domain 10-1. A user terminal 12 is disposed in the user domain 10-2. A user terminal 13 is disposed in the user domain 10-3. The basic task system center 11 is connected with the edge node 21-1. The user terminals 12 and 13 are connected with the edge node 21-2.

The inside of each of the user domains 30-1 and 30-2 is composed of a bus-structured network. In FIG. 4, a basic task system center 31 and a user terminal 32 are positioned in the user domain 30-1. User terminals 33, 34 and a router 35 are disposed in the user domain 30-2. The user terminals 33 and 34 are connected with the router 35. The basic task system center 31 and user terminal 32 are connected with the edge node 22-1. The router 35 is connected with the edge node 22-2.

The edge node 21-1 has a transfer control portion 21a having the functions of both of the ingress transfer control portion 2a and egress transfer control portion 2b shown in FIG. 1. The edge node 22-1 has a transfer control portion 22a having the functions of both of the ingress transfer control portion 2a and egress transfer control portion 2b shown in FIG. 1. The edge nodes 21-2 and 22-2 have similar transfer control portions (not shown).

If the definitions of the important flow packets are set in the ACL of the transfer control portion 21a at the edge node 21-1, a connection C1 for transfer of important flow packets is automatically established from the edge node 21-1 to the edge node 22-1.

The connection C1 for transfer of important flow packets is a TCP connection for transferring the important flow packets f1 from the edge node 21-1 to the edge node 22-1. The packets pass through the edge node 21-1, core codes R1, R2, and the edge node 22-1 in this order within the provider domain 20.

If the definitions of the important flow packets are set in the ACL of the transfer control portion 22a of the edge node 22-1, a connection C2 for transfer of important flow packets is automatically established from the edge node 22-1 to the edge node 21-1.

The connection C2 for transfer of important flow packets is a TCP connection for transferring the important flow packets f1 from the edge node 22-1 to the edge node 21-1. The packets pass through the edge node 22-1, core nodes R3, R4, and the edge node 21-1 in this order within the provider domain 20.

In this way, a connection for transfer of important flow packets is established in each one direction. This assures the security service of the destination reachability of the user flow packets passing through the provider domain 20. Note that the treated user flow packets are restricted to the important flow packets f1 contracted between the user and provider.

(1) Where important flow packets are transferred from the basic task system center 11 to the user terminal 32, the following procedure is adopted.

The basic task system center 11 forwards user flow packets f0 to the edge node 21-1. The transfer control portion 21a in the edge node 21-1 distributes the received user flow packets f0 between the important flow packets f1 and general flow packets f2 according to the previously set definitions of the important flow packets.

The general flow packets f2 are forwarded with the ordinary IP routing. The important flow packets f1 are encapsulated in the connection header for transfer of important flow packets by the transfer control portion 21a and forwarded over the connection C1 for transfer of important flow packets.

On receiving packets, the transfer control portion 22a in the edge node 22-1 makes a decision as to whether or not the received packets are important flow packets according to the previously stored connection TCP port for transfer of important flow packets. If the received packets are encapsulated important flow packets, the control portion decapsulates the packets from the connection header for transfer of important flow packets and forwards the decapsulated important flow packets f1 to the user terminal 32.

(2) Where user flow packets are forwarded from the basic task system center 31 to the basic task system center 11, the following procedure is adopted.

The basic task system center 31 forwards the user flow packets f0 to the edge node 22-1. The transfer control portion 22a in the edge node 22-1 distributes the received user flow packets f0 between the important flow packets f1 and general flow packets f2 according to the previously set definitions of the important flow packets.

The general flow packets f2 are forwarded with the ordinary IP routing but the important flow packets f1 are encapsulated in the connection header for transfer of important flow packets by the transfer control portion 22a and forwarded over the connection C2 for transfer of important flow packets.

On receiving the packets, the transfer control portion 21a in the edge node 21-1 makes a decision as to whether or not the received packets are important flow packets according to the previously stored connection TCP port for transfer of important flow packets. If they are encapsulated important flow packets, the control portion decapsulates the packets from the connection header for transfer of important flow packets and forwards the decapsulated important flow packets f1 to the basic task system center 11.

A connection for transfer of important flow packets is established in each direction. Therefore, the definitions of the important flow packets used for distribution of flow packets may be set only for the edge node on the entrance side of the provider domain 20. In the example shown in FIG. 4, communications are performed while establishing the connections C1 and C2 for transfer of important flow packets in both directions. Therefore, it follows that mutually independent important flow packet definitions are set for the edge nodes 21-1 and 22-1.

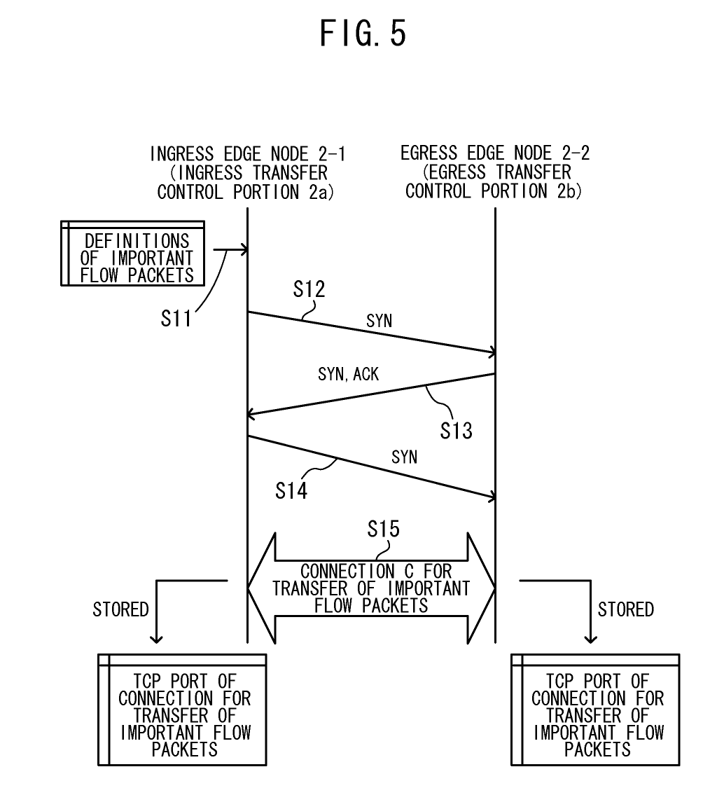

Automatic setting of connection C for transfer of important flow packets is next described. FIG. 5 is a diagram illustrating a sequence of steps performed until the connection C for transfer of important flow packets is automatically established.

Provider maintenance personnel sets the definitions of important flow packets as access control entries to the ingress transfer control portion 2a of the ingress edge node 2-1 (step S11).

When the definitions of the important flow packets are set, the ingress transfer control portion 2a forwards an acknowledgement request (SYN) to the egress transfer control portion 2b of the egress edge node 2-2 (step S12). The egress transfer control portion 2b forwards the SYN and an acknowledgement (ACK) to the ingress transfer control portion 2a (step S13).

The ingress transfer control portion 2a forwards the SYN to the egress transfer control portion 2b of the egress edge node 2-2 (step S14).

The ingress transfer control portion 2a and egress transfer control portion 2b store the TCP port of the connection C for transfer of important flow packets (step S15). Because of this sequence, the connection C for transfer of important flow packets is automatically established between the I/F address on the user side of the ingress edge node 2-1 and the I/F address on the user side of the egress edge node 2-2, the addresses being written in the definitions of the important flow packets.

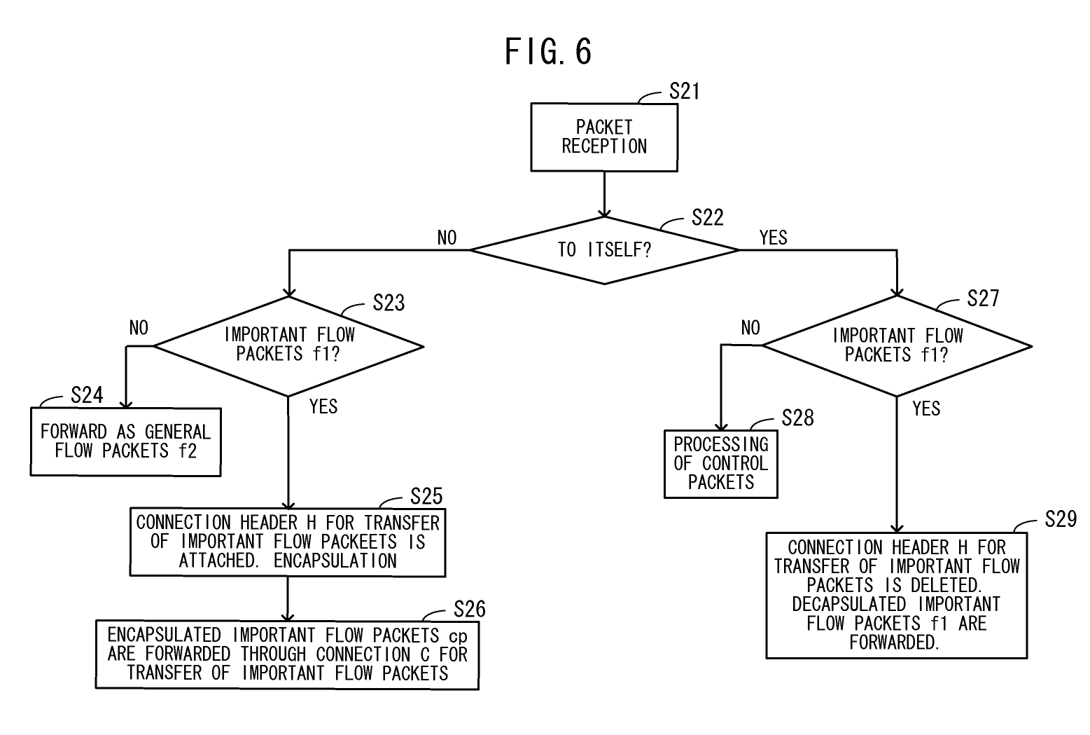

Packet processing performed after the flow decision is next described by referring to a flowchart. In the description made in connection with FIG. 4, the nodes in the provider domain 20 are discriminated between edge nodes and core nodes. In practice, the functions of the edge nodes and core nodes can be incorporated into one node, which is referred to as a provider node. Flow of forwarded packets in the provider node is illustrated in FIG. 6.

FIG. 6 is a flowchart illustrating the packet processing performed after the flow decision. The provider node receives packets (step S21). The provider node makes a decision as to whether or not the received packets are directed to itself (step S22).

If the packets are not directed to itself, program control goes to step S23. If the packets are directed to itself, program control proceeds to step S27.

If the packets received by the provider node are not directed to itself, the received packets are user traffic, i.e., packets sent out by the user. The provider node searches the access control entries (definitions of the important flow packets). A decision is made according to the results of the search as to whether the received packets are the important flow packets f1 (step S23). If the received packets are not the important flow packets f1, program control goes to step S24. If the received packets are the important flow packets f1, program control proceeds to step S25.

The provider node forwards the received packets as the general flow packets f2 (step S24). The general flow packets f2 are forwarded with hop-by-hop IP routing.

The provider node attaches the connection header H for transfer of important flow packets to the received packets, encapsulates the packets, and creates the encapsulated important flow packets cp (step S25).

The provider node sends the encapsulated important flow packets cp through the connection C for transfer of important flow packets (step S26).

The provider node searches the headers of the received packets and makes a decision as to whether or not there is the port number given to the TCP port for the currently established connection C for transfer of important flow packets (step S27). If the port number given to the TCP port for the connection C is not found, program control goes to step S28. If the port number is found, program control proceeds to step S29.

Because the received packets are control traffic (control packets), the provider node performs normal processing for the control packets (step S28).

The provider node deletes the header H for connection for transfer of important flow packets to decapsulate the packets and forwards the decapsulated important flow packets f1 to a user site.

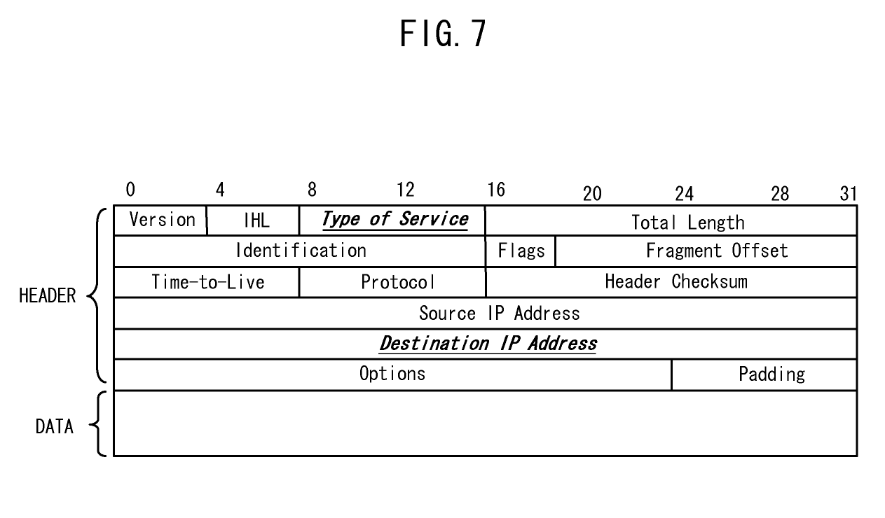

A specific example in which a search is performed to confirm that the packets are important flow packets using access control entries is next described. FIG. 7 is a diagram illustrating processing steps for searching for important flow packets.

The conditions (items of definitions of the important flow packets) under which packets are regarded as important flow packets are so set, for example, that the Destination IP address is the IP address (e.g., 192.168.10.10) of the originating user terminal 1a. It is assumed that the low-delay bit and high-reliability bit in a Type of Service field (8 bits) are set to 1.

In the present example, the low delay bit is the fourth bit in the Type of Service field. The high reliability bit is the sixth bit in the Type of Service field. The ingress transfer control portion 2a holds access control entries in which the definitions of the important flow packets are written.

On receiving user packets sent from the originating user terminal 1a, the ingress transfer control portion 2a reads the packet headers and performs a search using access control entries. If the Destination IP Address of the packet headers is 11000000 10101000 00001010 00001010 (=192.168.10.10) and if the Type of Service is 00010100, the received user packets are recognized as the important flow packets f1. Forwarding processing for the important flow packets f1 is performed.

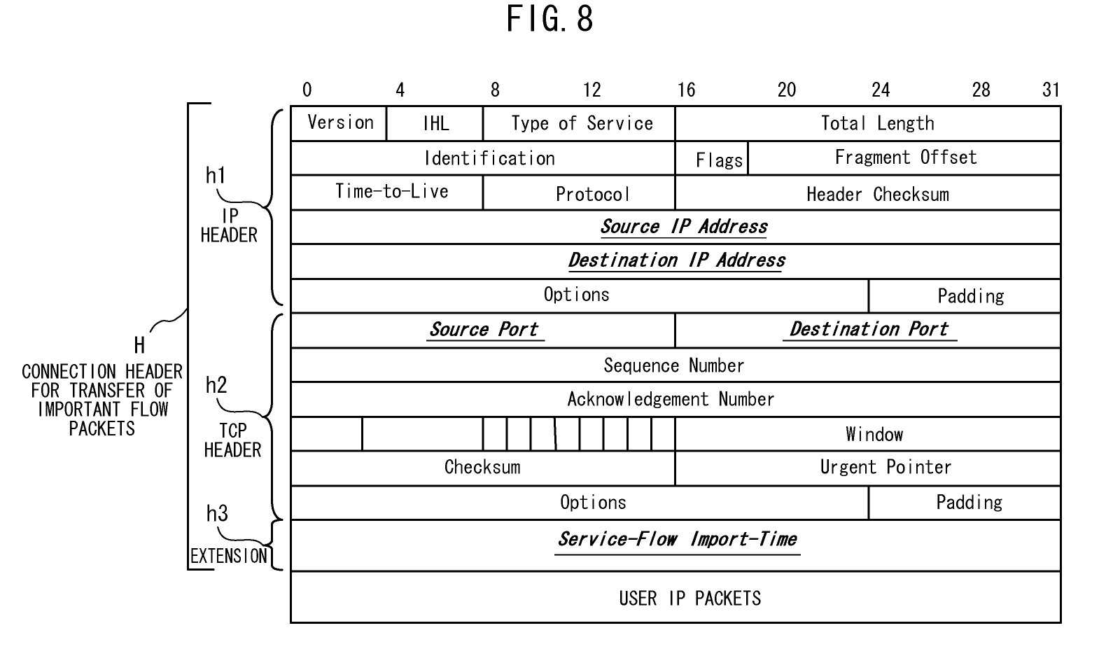

The connection header H for transfer of the important flow packets is next described. FIG. 8 shows the connection header H for transfer of important flow packets. The header H is composed of an IP header portion h1, a TCP header portion h2, and an extension portion h3. When the packets are encapsulated, the header is attached to the user packets that are important flow packets f1. As shown in FIG. 8, general-purpose IP header or TCP header is employed as the connection header H for transfer of important flow packets.

The Source IP Address field of the IP header portion h1 contains the I/F address on the user side at the ingress edge node 2-1, the address being a defined item of the important flow packets. The Destination IP Address field contains the I/F address on the user side at the egress edge node 2-2, the address being a defined item of the important flow packets.

The number given to the source TCP port of the connection C for transfer of important flow packets is written in the Source Port field in the TCP header portion h2. The number given to the destination TCP port of the connection C for transfer of important flow packets is written in the Destination Port field.

A data item “Service-Flow Import-Time” is written in the extension portion h3. This represents the time at which the ingress edge node 2-1 received the user packets.

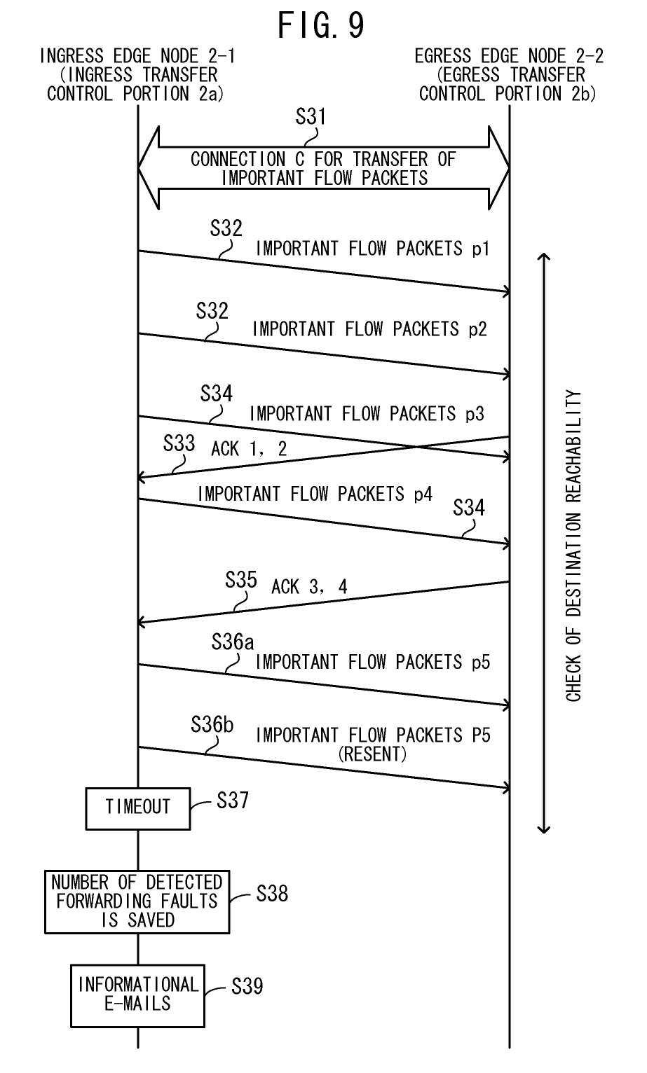

A routine for checking the destination reachability and a routine for detecting a forwarding fault are next described. FIG. 9 is a diagram illustrating a sequence of steps performed to check the destination reachability when user's packets are communicated, as well as a sequence of steps performed to detect a forwarding fault.

The connection C for transfer of important flow packets is established between the ingress edge node 2-1 and the egress edge node 2-2 (step S31).

The ingress transfer control portion 2a forwards important flow packets p1 and p2 to the egress edge node 2-2 through the connection C for transfer of important flow packets (step S32).

The egress transfer control portion 2b sends ACK1 indicating reception of the important flow packets p1 and ACK2 indicating reception of the important flow packets p2 to the ingress edge node 2-1. The ingress transfer control portion 2a has an internal ACK-waiting timer, and checks that the important flow packets p1 and p2 have been normally forwarded by receiving the ACK1 and ACK2 within a prescribed period of time (step S33).

The ingress transfer control portion 2a forwards important flow packets p3 and p4 to the egress edge node 202 through the connection C for transfer of important flow packets (step S34).

The egress transfer control portion 2b sends ACK3 indicating reception of the important flow packets p3 and ACK4 indicating reception of the important flow packets p4 to the ingress edge node 2-1. The ingress transfer control portion 2a checks that the important flow packets p3 and p4 have been normally forwarded by receiving ACK3 and ACK4 within a prescribed period of time (step S35).

The ingress transfer control portion 2a forwards important flow packets p5 to the egress edge node 2-2 through the connection C for transfer of important flow packets (step S36a).

As an example, the ingress transfer control portion 2a does not receive an ACK within the prescribed period of time. Therefore, the important flow packets p5 are again forwarded to the egress edge node 2-2 through the connection C for transfer of important flow packets (step S36b).

The ingress transfer control portion 2a does not receive ACK that is an acknowledgement for the important flow packets p5 and times out. Thus, the control portion recognizes that a forwarding fault has occurred (step S37).

The ingress transfer control portion 2a increments the number of detected forwarding faults and saves information about a log of forwarding faults that is statistical information, together with the times at which the faults were detected (step S38).

If the destination reachability of the important flow packets contracted as important flow packets cannot be checked (i.e., a forwarding fault is detected), the ingress transfer control portion 2a refers to the definitions of the important flow packets and informs persons involved in the contract of the fault using emails. Because information about the detection of the forwarding fault is given to the involved persons, the user can make a decision as to whether or not packets can be forwarded (step S39).

Information about the log of forwarding faults is periodically collected as indicator data based on an SLA (Service Level Agreement) from a network management system (NMS) for managing the IP network. The SLA is a contract based on definite agreements previously made between the user and provider regarding the contents and scope of services and a required level of quality, and includes rules applied in cases where these requirements cannot be met.

One response to the SLA is to send informational emails to the persons concerned when destination reachability cannot be checked as in step S39 described previously. Another response is to set the number of forwarding faults detected during the time interval of 7:00-22:00 in week days per year to 12 or less. A further response is to set the average in-network delay time during the time interval of 7:00-22:00 in week days per year to 1 second or less.

Information about the log of forwarding faults is periodically collected by the maintenance personnel and disclosed to the user as data proving achievement of the service level agreement (SLA). Thus, it is checked whether the service level agreement is satisfied.

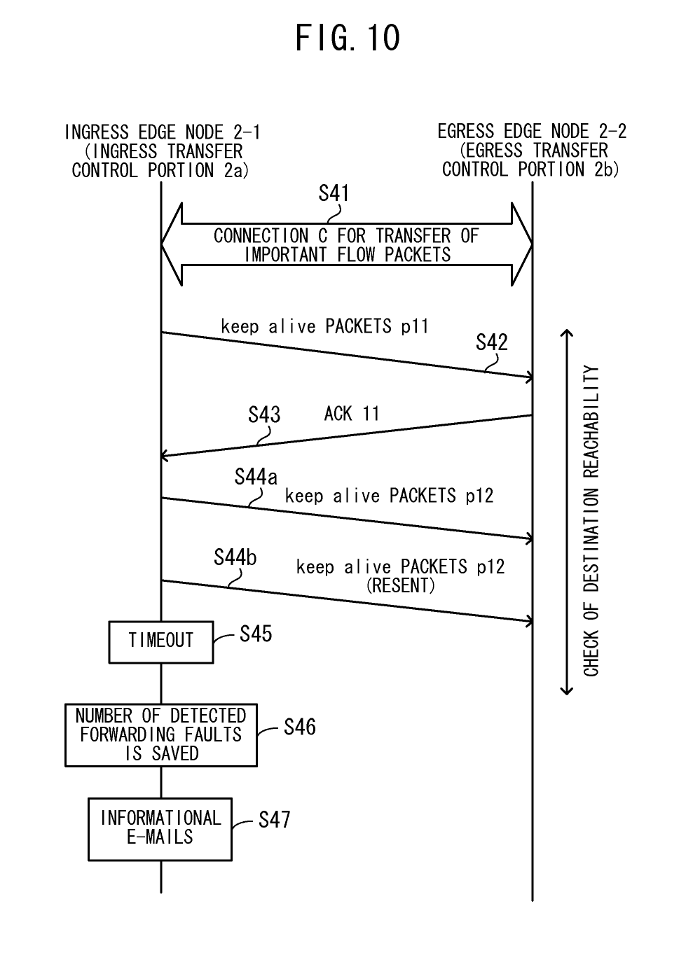

FIG. 10 is a diagram illustrating a routine for checking the destination reachability when user's packets are not communicated. A routine for detecting forwarding faults is also illustrated. Even during the time interval in which the important flow packets f1 are not communicated, dummy packets (e.g., keep-alive packets) are generated and sent from the ingress edge node 2-1 in order to continually carry out the routine for checking the destination reachability and the routine for detecting forwarding faults.

The connection C for transfer of important flow packets is established between the ingress edge node 2-1 and the egress edge node 2-2 (step S41).

The ingress transfer control portion 2a of the ingress edge node 2-1 forwards keep-alive packets p11 to the egress edge node 2-2 through the connection C for transfer of important flow packets (step S42).

The egress transfer control portion 2b of the egress edge node 2-2 sends ACK11 indicating reception of the keep-alive packets p11 to the ingress edge node 2-1 (step S43). The ingress transfer control portion 2a has an internal ACK waiting timer, and checks that the keep-alive packets p11 have been normally forwarded by receiving ACK11 within a prescribed period of time.

The ingress transfer control portion 2a forwards keep-alive packets p12 to the egress edge node 2-2 through the connection C for transfer of important flow packets (step S44a) As an example, the ingress transfer control portion 2a does not receive the ACK within the prescribed time. Therefore, the control portion 2a again forwards the keep-alive packets p12 to the egress edge node 2-2 through the connection C for transfer of important flow packets (step S44b).

The ingress transfer control portion 2a does not receive the ACK that is an acknowledgement for the keep-alive packets p12 and times out. The control portion recognizes that a forwarding fault has occurred (step S45).

The ingress transfer control portion 2a increments the number of detected forwarding faults and saves information about the log of forwarding faults together with the times at which the faults were detected (step S46).

Where the destination reachability of the packets of the user who has contracted for the important flow packets cannot be checked (i.e., a forwarding fault is detected), the ingress transfer control portion 2a refers to the definitions of the important flow packets and sends informational emails to the persons concerned with the contract (step S47).

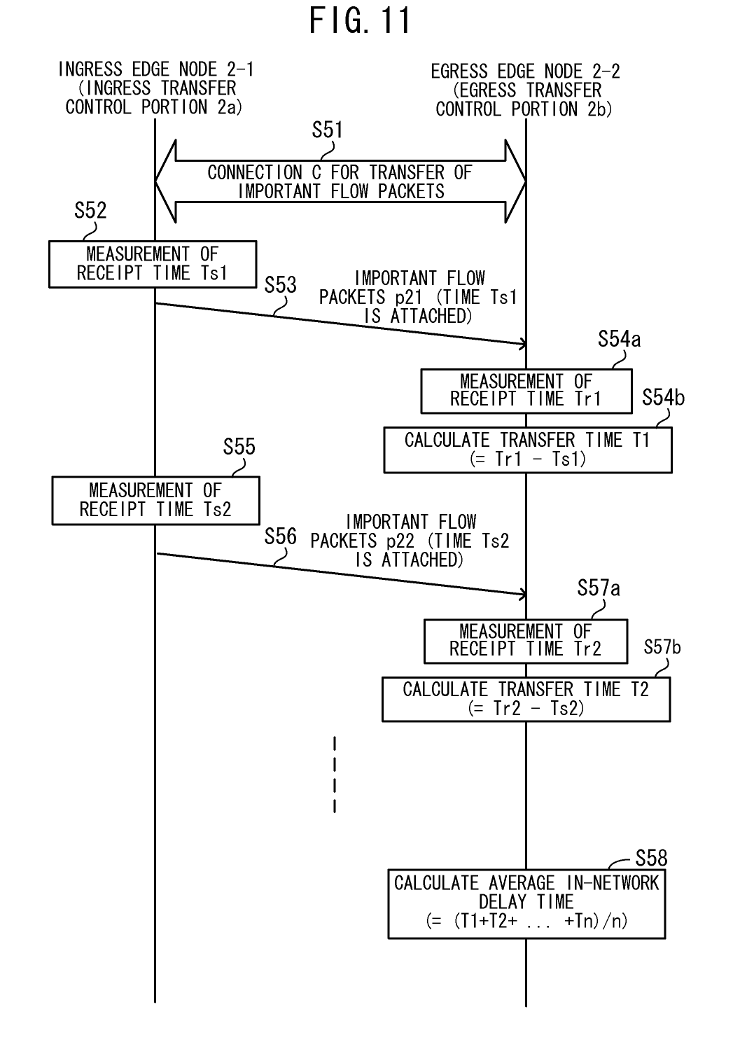

A routine for measuring the packet transfer time is next described. FIG. 11 is a diagram illustrating the routine for measuring the packet transfer time.

The connection C for transfer of important flow packets is established between the ingress edge node 2-1 and the egress edge node 2-2 (step S51).

The ingress transfer control portion 2a measures a time Ts1 at which important flow packets sent from the originating user terminal 1a were received (step S52).

The ingress transfer control portion 2a attaches the receipt time Ts1 to the header and forwards important flow packets p21 to the egress edge node 2-2 (step S53).

The egress transfer control portion 2b measures a receipt time Tr1 when the important flow packets p21 are received (step S54a). The egress transfer control portion 2b calculates and saves a transfer time T1(=Tr1−Ts1) (step S54b).

The ingress transfer control portion 2a measures a receipt time Ts2 of the important flow packets sent from the originating user terminal 1a (step S55). The ingress transfer control portion 2a attaches the receipt time Ts2 to the header and forwards important flow packets p22 to the egress edge node 2-2 (step S56).

The egress transfer control portion 2b measures a receipt time Tr2 when the important flow packets p22 are received (step S57a). The egress transfer control portion 2b calculates and saves a transfer time T2(=Tr2−Ts2) (step S57b).

The egress transfer control portion 2b calculates the average value of transfer times T1, T2, . . . , Tn per unit time and stores an average in-network delay time as statistical information, the average delay time being the average value of the average transfer time. The average in-network delay time is periodically collected as indicator data based on the SLA (Service Level Agreement) from the NMS that manages the IP network (step S58).

For example, if the SLA (Service Level Agreement) includes an item stating that the average in-network delay time during the time interval 7:00-22:00 in week days per year is set to 1 second or less, the maintenance personnel is periodically informed of the average in-network delay time. Also, the time is disclosed as data proving the achievement of the service level agreement to the user. A check is made as to whether or not the service level agreement is met.

As described thus far, in the communication system 1, the routine for checking the destination reachability within the provider domain 20 is carried out and, therefore, the service provider can assure the user of the destination reachability of user flow packets within an IP network in the same way as in an OSI network.

Furthermore, the service provider can detect a fault occurring in forwarding user flow packets in an IP network in the same way as in an OSI network. As a result, the user can be informed of forwarding faults. When forwarding is impossible, the user can be informed of the status. Further, it is possible to collect indicator data (information about a log of forwarding faults) based on the service level agreement (SLA) with the user.

In addition, the service provider can measure the in-network transmission time of user flow packets. As a result, it is possible to collect indicator data (average in-network delay time) based on the service level agreement (SLA) with the user.

The service menu offered by the service provider can be made more versatile by determining the service contract with the user so as to specify and include important flow packets.

In the case of an MPLS (multiprotocol label switching) network, when the equipment is renewed, it is necessary to renew all the facilities within the provider domain 20 including core routers. However, renewed facilities within the provider domain 20 can be limited to the edge routers accommodating users having contracts regarding important flow packets by applying the functions of the communication system 1 described previously. That is, when a system is developed, it can be started with simple equipment instead of providing large-scale, multifunctional equipment from the beginning.

What is claimed is:

1. A communication system for performing communications on a network, comprising:
an originating user terminal;
a destination user terminal;
an ingress edge node disposed at an ingress edge of a provider domain and including an ingress transfer control portion for controlling forwarding of packets forwarded from the originating user terminal; and
an egress edge node disposed at an egress edge of the provider domain and including an egress transfer control portion for controlling forwarding of the packets forwarded from the ingress edge node;
wherein a connection for transfer of important flow packets is established between the ingress transfer control portion and the egress transfer control portion within the provider domain;
wherein the ingress transfer control portion makes a decision as to whether user flow packets forwarded from the originating user terminal are important flow packets and, if the user flow packets are the important flow packets, the ingress transfer control portion encapsulates the important flow packets and forwards them through the connection for transfer of important flow packets; and
wherein the egress transfer control portion decapsulates the encapsulated important flow packets received through the connection for transfer of important flow packets and forwards the decapsulated important flow packets to the destination user terminal.

2. A communication system as set forth in claim 1,
wherein when important flow packet definition information used to make a search for making a decision as to whether the user flow packets holding an interface address on a user side of the ingress edge node connected with the originating user terminal and an interface address on a user side of the egress edge node connected with the destination user terminal is set, said ingress transfer control portion automatically establishing the connection for transfer of the important flow packets between the interface address on the user side of the originating user terminal and the interface address on the user side of the destination user terminal;
wherein the ingress transfer control portion and the egress transfer control portion store a port number given to the connection for transfer of the important flow packets;
wherein the ingress transfer control portion attaches a header including the port number to the important flow packets and creates encapsulated important flow packets; and
wherein the egress transfer control portion recognizes received packets as the encapsulated important flow packets in a case where the received packets contain the port number and decapsulates the received packets.

3. A communication system as set forth in claim 1, wherein when said important flow packets are forwarded via said connection for transfer of the important flow packets and an acknowledgement to be sent from said egress transfer control portion is not received within a prescribed period of time, said ingress transfer control portion produces an output indicating that destination reachability cannot be checked.

4. A communication system as set forth in claim 1, wherein when no communications are performed, said ingress transfer control portion forwards dummy packets via said connection for transfer of the important flow packets and checks destination reachability, and wherein, when an acknowledgement to be sent from said egress transfer control portion is not received within a prescribed period of time, the ingress transfer control portion produces an output indicating that destination reachability cannot be checked.

5. A communication system as set forth in claim 1, wherein said ingress transfer control portion measures a first receipt time at which the important flow packets sent from said originating user terminal were received, attaches the first receipt time to the important flow packets, and forwards the packets through said connection for transfer of the important flow packets, and wherein said egress transfer control portion measures a second receipt time at which the important flow packets are received through said connection for transfer of the important flow packets, finds a transfer time being a difference between the first receipt time and the second receipt time, finds the transfer times for n important flow packets, and averages the found transfer times to calculate an average in-network delay time.

6. A communication system for performing communications on a network, comprising:
a user terminal; and
an edge node disposed at an edge of a provider domain and having a transfer control portion for controlling forwarding of packets forwarded from an originating user terminal or packets forwarded from another edge node;
wherein when definitions of important flow packets are set in the edge node, said transfer control portion establishes a connection for transfer of important flow packets between an edge node with which the originating user terminal is connected and an edge node with which a destination user terminal is connected, and makes a decision based on the definitions of the important flow packets as to whether user flow packets forwarded from the originating user terminal are important flow packets; and
wherein if the decision is that the user flow packets are the important flow packets, the transfer control portion encapsulates the packets and forwards them through said connection for transfer of the important flow packets.
